(19) United States
(12) Patent Application Publication
(10) Pub. No.: US 2016/0149765 A1
(43) Pub. Date: May 26, 2016

(54) SYSTEM AND METHOD FOR EXTRACTING PROTOCOL INFORMATION FROM A SIMULATION ENVIRONMENT TO ANALYZE SYSTEM BEHAVIOR

(71) Applicant: ARROW DEVICES PRIVATE LIMITED, Bangalore (IN)

(72) Inventors: Aditya Mittal, Bangalore (IN); Shrihari Voniyadka, Bangalore (IN)

(21) Appl. No.: 14/950,412

(22) Filed: Nov. 24, 2015

(30) Foreign Application Priority Data
Nov. 24, 2014 (IN) 5872/CHE/2014

(51) Int. Cl. H04L 12/24; H04L 29/06

(52) U.S. Cl. CPC H04L 41/145; H04L 69/02

(57) ABSTRACT

A system and method for extracting protocol information from a simulated or emulated design to analyze system behavior is disclosed. The system includes a database, a signal extraction module, a signal processing module, a protocol parsing module, a multi-level protocol parsing module, a protocol rule description table, a display module, an extracted protocol information table, and a debug automation module. The signal extraction module extracts signal level information to generate stream of bits. The protocol parsing module applies BNF grammar rules on stream of bits to generate lower level protocol information. The multi-level parsing module constructs a multiple hierarchy levels of protocol information by creating a tree structure based on a lower level protocol. The higher level protocol information determines operations. The higher level protocol information and the operations are associated with a protocol pattern which is being parsed.

### CROSS-REFERENCE TO RELATED APPLICATIONS

This application claims priority to Indian patent application no. 5872/CHE/2014 filed on Nov. 24, 2014, the complete disclosure of which, in its entirely, is herein incorporated by reference.

### BACKGROUND

1. Technical Field

The embodiments herein generally relate to data management, and, more particularly, to system and method for extracting protocol information from a simulation or an emulation environment to analyze and debug a system behavior.

2. Description of the Related Art

Traditionally, engineers rely on information contained in log files (generated by a master/slave models) and/or waveform signal level dump files (generated by simulators) to analyze a system behavior or to debug a problem. However, while using information in the signal level dump or log files for debugging errors in a system, user might face several challenges such as, (a) the log files having more unnecessary data, (b) formats not being standardized and thereby causing a difficulty in extracting meaningful information from a unstructured data, and (c) the waveform signal level dump files having very low signal level information and the information not being provided at a transaction level abstraction or software transfer level abstraction.

The transaction level abstraction and software transfer level abstraction may conform to Open Systems Interconnection model (OSI) mod. The OSI module is a conceptual model that characterizes and standardizes the communication functions of a telecommunication or computing system without regard to their underlying internal structure and technology. The OSI model includes seven layers and the seven layers are a first layer, a second layer, a third layer, a four layer, a fifth layer, a sixth layer and a seventh layer. The first layer defines electrical and physical specifications of the data connection (for example signal level information or signal toggles). The second layer provides node to node data transfer and is specific to a protocol. The third layer provides the functional and procedural means of transferring variable length data sequence from one node to another connected to the same network. The third layer translates logical network address into physical machine address. The fourth layer controls the reliability of a given link through flow control, segmentation/desegmentation, and error control. The fourth layer creates packets out of the message received from the seventh layer. Packetizing is a process of dividing the long message into smaller messages. The fifth layer provides for full-duplex, half-duplex, or simplex operation, and establishes checkpointing, adjournment, termination, and restart procedures. The sixth layer transforms data into the form that the seventh layer accepts. The sixth layer formats and encrypts data to be sent across a network and is also called as syntax layer. The seventh layer interacts with software applications that implement a communicating component.

Error scenarios may be debugged using waveform viewers in which the waveforms provided are very structured data, however while using such method may cause difficulty in analyzing the protocol level information in higher abstraction levels. In order to debug such issues/errors in a simulation environment, most electronic design automation (EDA) tools depend on data/information provided by a master/slave functional model. But, this method of debugging has one or more drawbacks such as, (a) the master/slave might not log all the required information, or the master/slave data may log unnecessary information along with required data which makes it difficult for the tool to get meaningful data from the log files, and (b) each master/slave model may follow different formats for logging. Hence it is difficult to extract accurate information on what is going on in the system. Accordingly there remains a need for a method of extracting relevant information from a simulation environment for better analysis of system behavior.

### SUMMARY

In one aspect, a system for extracting protocol information from a simulated or an emulated design to analyze a system behavior is disclosed. The system includes a memory unit that stores a database, a set of modules, and instructions. The database includes a protocol rule description table and an extracted protocol information table. The protocol rule description table includes one or more protocol rules to process a signal level information and the extracted protocol information table includes protocol information specific to protocol. The processor which when configured by the instructions executes the set of modules and the set of modules includes a signal extraction module to extract a signal level information from an interface of simulated or emulated design to generate a stream of bits. A signal processing module processes the stream of bits based on one or more protocol rules to obtain protocol information that includes a lower level protocol information and a higher level protocol information. The one or more protocol rules include backus naur form (BNF) grammar rules and the one or more protocol rules are specific to a protocol. The signal processing module includes a protocol parsing module that applies BNF grammar rules on the stream of bits to generate lower level protocol information. A multi-level parsing module constructs multiple hierarchy levels of the protocol information by creating a tree structure based on the lower level protocol information of the protocol which is being parsed to obtain higher level protocol information to determine operations. The tree structure includes branches and leaves. If the protocol is Universal Serial Bus (USB) then the extracted protocol information table includes packets, transactions, transfers, if the protocol is AXI then the extracted protocol information table includes phases and transactions, if the protocol is Ethernet networking OSI model then the extracted protocol information table includes data, segments, datagram, packets and frames, if the protocol is Unipro then the extracted protocol information table includes data, messages, segments, packets, frames, and symbols, if the protocol is Serial AT Attachment (SATA) then the extracted protocol information table includes commands, data, frames, and FIS packets, and if the protocol is Peripheral Component Interconnect Express (PCIE) then the extracted protocol information table includes commands, data, interrupts, translation packet, and data link layer packets.

In an embodiment, the signal processing module eliminates an unrecognized stream of bits from being parsed. A debug automation module automates a debug process by writing scripts that process the protocol information based on the protocol. The multi-level parsing module is obtained from plurality of protocol parsing module and the protocol parsing module is used to convert signal level information into user readable language.

In another aspect, a processor implemented method for analyzing system behavior by parsing a stream of bits extracted from a simulated or an emulated design is disclosed. The processor implemented method for analyzing system behavior by parsing includes the following steps: (i) obtaining a signal level information from an interface of a simulated or an emulated design, (ii) generating a stream of bits based on the signal level information obtained from the interface of the simulated or the emulated design, (iii) processing the stream of bits based on one or more protocol rules to generate a protocol information and one or more protocol rules include BNF grammar rules, (iv) applying BNF grammar rules on the stream of bits to generate a lower level protocol information and the lower level protocol information is associated with a protocol information, and (iv) eliminating an unrecognized stream of bits from being parsed. In an embodiment, the processor implemented method also includes the following steps (v) constructing a multiple hierarchy levels of the lower level protocol information based on a multi-level parsing to obtain a higher level protocol information for determining operations. The multi-level parsing is performed by creating a tree structure and the tree structure comprises branches and leaves, (vi) The lower level protocol information, the higher level protocol information, and the operations are specific to a protocol, (viii) automating a debug process by writing scripts that process the protocol information, and (ix) checking the protocol information to debug an error through a graphical user interface when one or more protocol rules are being violated.

In yet another aspect, a non-transitory program storage device readable by computer, and comprising a program of instructions executable by the computer to analyzes system behavior by parsing a stream of bits extracted from a simulated or an emulated design is disclosed and the method includes the following steps (i) obtaining a signal level information from an interface of a simulated or an emulated design, (ii) generating a stream of bits based on the signal level information obtained from the interface of the simulated or the emulated design, (iii) processing the stream of bits based on one or more protocol rules to generate a protocol information and one or more protocol rules include BNF grammar rules, (iv) applying BNF grammar rules on the stream of bits to generate a lower level protocol information and the lower level protocol information is associated with a protocol information, and (iv) eliminating an unrecognized stream of bits from being parsed. In an embodiment, the processor implemented method also includes the following steps (v) constructing a multiple hierarchy levels of the lower level protocol information based on a multi-level parsing to obtain a higher level protocol information for determining operations. The multi-level parsing is performed by creating a tree structure and the tree structure comprises branches and leaves, (vi) The lower level protocol information, the higher level protocol information, and the operations are specific to a protocol, (viii) automating a debug process by writing scripts that process the protocol information, and (ix) checking the protocol information to debug an error through a graphical user interface when one or more protocol rules are being violated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates an exploded view of a protocol information extraction tool, according to an embodiment herein;

FIG. 2 illustrates a pipeline diagram of the protocol information extraction process, parsing and trace extracting process using a protocol parsing module, according to an embodiment herein;

FIG. 3 illustrates a pipeline diagram of the protocol information extraction process, parsing and trace extracting process using a multi-level parsing module, according to an embodiment herein;

FIG. 4 illustrates a block diagram of a multi-level parsing operation, according to an embodiment herein;

FIG. 5 illustrates an exemplary view of a protocol information extraction from field-programmable gate array (FPGA)/Emulator, according to an embodiment herein;

FIG. 6 is a flow diagram illustrating a method of extracting a protocol information from an interface to analyze behavior and debug one or more error/issue associated with the device under test (DUT), according to an embodiment herein;

FIG. 7 is a flow diagram illustrating a method for eliminating an unrecognized stream of bits from being parsed by the protocol information extraction tool according to an embodiment herein;

FIG. 8 is a flow diagram illustrating a method for automating a debug process by writing scripts on a protocol information according to an embodiment herein;

FIG. 9 illustrates a tabular view of different types of protocol along with protocol information according to an embodiment herein;

FIG. 10 is a user interface view illustrating a signal toggle for a USB2 protocol, according to an embodiment herein;

FIG. 11 illustrates a user interface view of a protocol information including a transaction type, transaction ID and address, extracted from signal level information exemplified in FIG. 10 according to an embodiment herein;

FIG. 12 illustrates a user interface view of selecting a protocol information error from a transaction type, according to an embodiment herein;

FIG. 13 illustrates a user interface view of a write transaction missing protocol information phase error, according to an embodiment herein;

FIG. 14 illustrates a user interface view of a multiple hierarchy levels of a protocol information, according to an embodiment herein;

FIG. 15 illustrates a user interface view of a lower level protocol information of USB2 protocol according to an embodiment herein; and

FIG. 16 illustrates a schematic diagram of a computer architecture used, in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

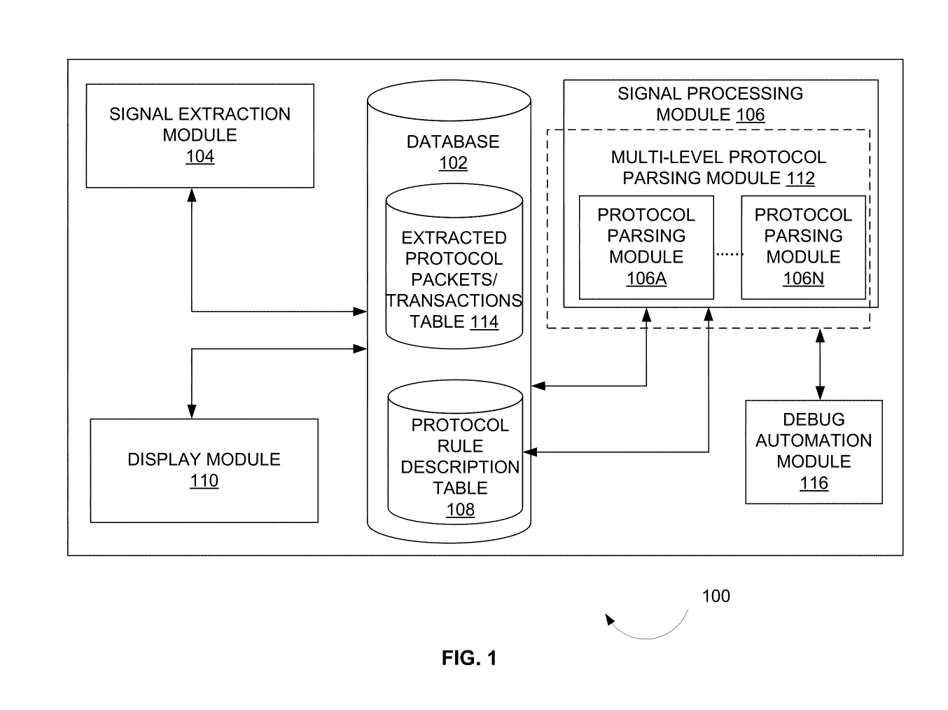

As mentioned, there remains need for a method of extracting relevant information from a simulated, emulated or prototype design for better analysis of system behavior. The embodiments herein achieve this by providing a protocol information extraction tool. The protocol information extraction tool acquires signal level information from an interface of the simulated/emulated design and then processes the signal level information based on one or more protocol rules, followed by the information flowing through the interface. The processing of the raw information from the interface is performed by parsing the information using a BNF grammar rules to deliver the protocol information. The protocol information, which is made available to the user through a graphical user interface (GUI) visualization, enables the user to debug protocol issues/error scenarios. Referring now to the drawings, and more particularly to FIGS. 1 through 16, where similar reference characters denote corresponding features consistently throughout the figures, there are shown preferred embodiments.

FIG. 1 illustrates an exploded view of the protocol information extraction tool 100 of FIG. 1 according to an embodiment herein. The protocol information extraction tool 100 includes a database 102, a signal extraction module 104, a signal processing module 106, a protocol parsing module 106A-106N, a multi-level protocol parsing module 112, a protocol rule description table 108, a display module 110, an extracted protocol information table 114, and a debug automation module 116. The database 102 stores all the processed protocol information. In an embodiment, the database 102 includes multiple databases. A graphical user interface (GUI) of a display module 110 provides visualization of the protocol information (such as packets, transactions and transfers) for debug process. The signal extraction module 104 extracts signal level information from the interface of the simulated or the emulated design (e.g., by plugging-in a monitor, or by reading signal level activity files or by electrically probing wire interfaces). Based on the signal level information a stream of bits is generated. The signal processing module 106 processes the stream of bits according to one or more protocol rules followed by the interface. The signal processing module 106 process (e.g., parsed) the stream of bits using BNF grammar rules (BNF grammars) and a higher level protocol information is constructed. In an embodiment the signal level information is referred as a data. In one embodiment, a subset of data is added to buffer and parsed to produce a higher level protocol information. This process continues until all the data is parsed and that results in reduced memory consumption. The signal processing module 106 includes a protocol parsing module 106A-106N and a multi-level parsing module 112. The multi-level parsing module 112 includes plurality of protocol parsing module 106A-106N and the plurality of protocol parsing module 106A-106N are chained together to form the multi-level parsing module 112. In an embodiment, the database 102 may include a signal database, and a transaction database. The signal database may include a signal table containing plurality of signal level information of a protocol and the transaction database may include plurality of higher level protocol information associated with a protocol.

For example a signal table with a time period associated with signal level information is shown below

| Time | Signals |
|---|---|
| T1 | 11001100 |
| T2 | 01010101 |
| T3 | 10111010 |

The time periods t1, t2, t3 and the associated signal level information at each time period is represented in the form of bits. The signal level information consists of arbitrary combination bits. A stream of bits may be generated using the time period and the signal level information. The stream of bits is shown below

| | | |
|---|---|---|
| 11001100 | 01010101 | 10111010 |

In an embodiment, the first part consists of the signal level information at time period t1, the second part contains signal level information at time period t2 and the third part contains signal level information at time period t3. Once the stream of bits are generated, the BNF grammar rules are applied on top of the stream of bits consisting of 1s and 0s. In an embodiment, parsing is applied on a stream of bits instead of characters. Generally, such BNF grammar rules are applied on characters not on stream of bits.

For example the BNF grammar rules for recognizing packets on the USB 2.0 interface is:

usb2_packets=″″″

usb2_packets=usb2_packet*

usb2_packet=usb2_packet_token/usb2_data_token/usb2_handshake_token/

usb2_sof_packet

usb2_packet_token=usb2_packet_token_pid usb2_packet_token_address

usb2_packet_token_endp usb2_crc5 usb2_eop

usb2_frame_number=˜“[01] {11}”

usb2_packet_token_address=˜“[01] {7}”

usb2_packet_token_endp=˜“[01] {4}”

usb2_crc5=˜“[01] {5}”

usb2_eop=˜“\−+”

usb2_packet_token_pid=usb2_packet_token_out/usb2_packet_token_in/

usb2_packet_token_setup/usb2_packet_token_ping

usb2_packet_token_out=“11100001”

usb2_packet_token_in=“01101001”

usb2_packet_token_setup=“00101101”

usb2_packet_token_ping=“10110100”

In an embodiment, For example the grammar syntax * may include zero or more stream of bits, usb2_packet_token/usb2_data_token/usb2_handshake_token/usb2_sof_packet where space is delimited, usb2_packet_token, usb2_data_token, usb2_handshake_token, and usb2_sof_packet may match input stream of bits, appearing in the same order, usb2_packet_token/usb2_data_token/usb2_handshake_token/usb2_sof_packet where/may be alternative in rule and first to succeed is usb2_packet_token /usb2_data_token/usb2_handshake_token/usb2_sof_packet and then the target rule is matched, “ ” may be literal and constants, token_packet+data_packet+handshake_packet may be one or more stream of bits, ! matches if packets are not found and doesn't consume stream of bits, and ( ) is for grouping. The USB2 packets may be of four types: token, data, handshake, and SOF. The BNF grammar rules parse the incoming stream of bits to find a USB2 Token packet. Additional rules that form a part of the BNF grammar may parse the incoming stream of bits to find a USB2 Data and Handshake packets (not shown in above example).

For example:

token_packet=“111000010000001000101011”

| pid | addr |endplcrc5 | //Fieldwise description

data_packet=“11000011010010001000100101000000”

| pid | data | crc16 | //Fieldwise description

handshake_packet=“11010010”

| pid | //Fieldwise description

stream=token_packet+data_packet+handshake_packet

stream

1110000100000010001010111100001101001000100010010100000011010010

| pid | addr |endplcrc5 | pid | data | crc16 | pid | //Fieldwise description.

Once the stream of bits is parsed based on the BNF grammar rules, the packets may appear as shown below:

| ID | Type | PID | Address | EndP | Data | DIR | CRC |
|---|---|---|---|---|---|---|---|
| 1 | usb2_pkt_token | 11100001 | 0000001 | 0001 | NA | Host | 01011 |
| 2 | usb2_pkt_data | 11000011 | 0000001 | 0001 | 010010000 | Host | 1000100101000000 |
| 3 | usb2_pkt_handshake | 11010010 | 0000001 | 0001 | NA | Device | NA |

In an embodiment, For example the USB2_packet is divided into four types. The four types of USB2 packets are an USB2_packet_handshake, an USB2_packet_token, and an USB2_packet_data. The protocol rule description table 108 obtains a higher level protocol information. The display module 110 provides visualization of the protocol information for a user through a graphical user interface (GUI) that enables the user to debug protocol issues/error scenarios. The protocol information includes the lower level protocol information and the higher level protocol information. The protocol information includes packets and transactions specific to a protocol being parsed. In an embodiment, the protocol may be USB, AXI, SATA, Ethernet networking OSI model, Unipro, SATA and PCIE.

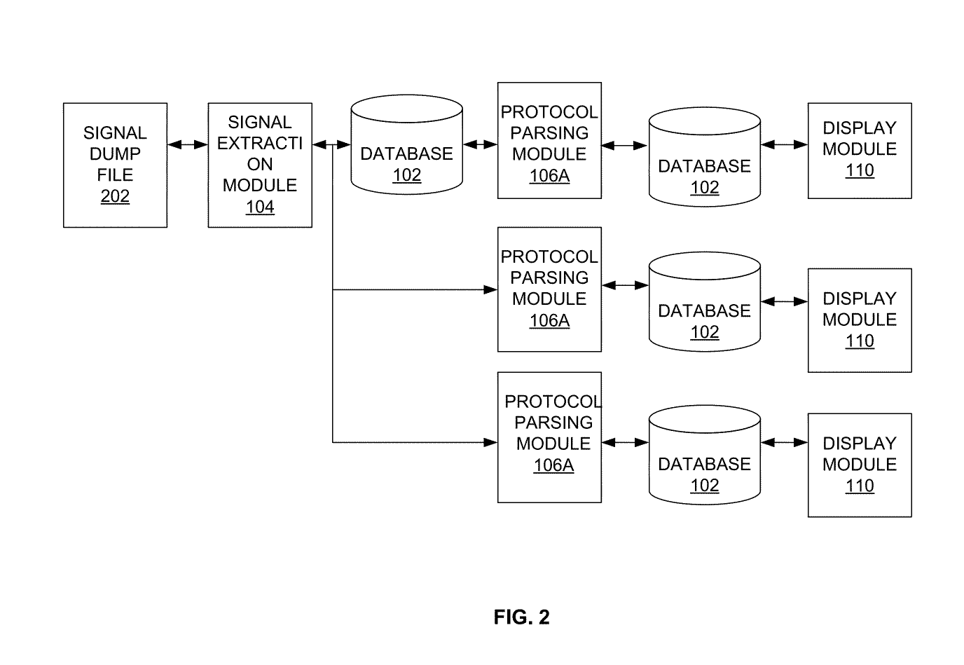

FIG. 2 illustrates a pipeline diagram of the protocol information extraction process, a parsing and a trace extracting process using a protocol parsing module, according to an embodiment. The pipeline diagram includes a signal dump file 202, signal extraction module 104, a database 102, a protocol parsing module 106A, and a display module 110. The signal dump file 202 is provided as an input to the signal extraction module 104 and the signal dump file 202 is a stream of bits. The protocol parsing module 106A applies protocol parsing on the stream of bits to obtain a lower level protocol information. The parsed stream of bits are stored in the database 102 and displayed to the user using the display module 110. In an embodiment, the signal dump file is a file that contains information about how signals toggle in a circuit in time. The signals may be viewed using a waveform viewer. A waveform viewer is a software tool for viewing the signal levels of either a digital or analog circuit design. The waveform viewers are of two varieties: a simulation waveform viewers for displaying signal levels of simulated design models, and in-circuit waveform viewers for displaying signal levels captured in-circuit while debugging or testing hardware boards.

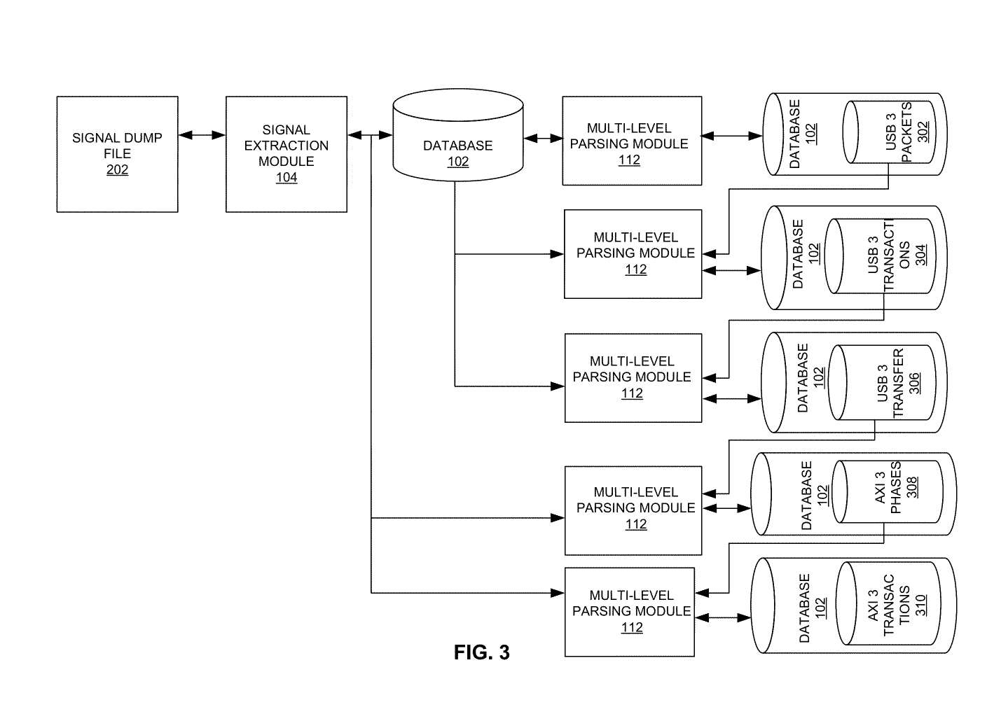

FIG. 3 illustrates a pipeline diagram of the protocol information extraction process, parsing and trace extracting process using a multi-level parsing module, according to an embodiment. The pipeline diagram includes a signal dump file 202, signal extraction module 104, a database 102, a multi-level parsing module 112, and a display module 110. A signal dump file is given as an input to the signal extraction module 104. A stream of bits is obtained using the signal level information and the stream of bits is fed to the database 102. The stream of bits is parsed by applying protocol parsing 106A to obtain lower level protocol information. The lower level protocol information is parsed using the multi-level parsing module 112 to generate higher level protocol information. In an embodiment, the multi-level parsing output at this stage is fed to the display module 110 and the display module 110 output is fed back to the database 102. In an embodiment, the signal level information is fed to a USB2 packet extractor that implements a packet grammar. The output of the USB2 packet extractor is fed back to the USB2 transaction extractor that implements a transaction grammar and the output of the USB2 transaction extractor is then fed back to the USB2 transfer extractor that implements a transfer grammar. The signal level information is also fed to AXI2 phase extractor that implements a phase grammar. The output of the AXI2 phase extractor is then fed back to AXI2 transaction extractor that implements a transaction grammar.

In an embodiment, the multi-level parsing process starts when the packets are created from the signals level information. The packets are stored into a packets database. This packets database is fed into the transaction parsing module and This multi-level parsing module recognizes transactions by combining multiple packets and stores these into the transaction database. In an embodiment, the parsing module has packets and multiple packets make a larger entity called a transaction. For example, a transaction is transaction=request_packet followed by a response packet. Similarly, data transaction=request_packet+response packet+data packet and command transaction=request_packet+response packet.

In an embodiment, a software function call at driver level may consist of a command transaction followed by a data transaction. There are three traces in the protocol information extracted by the protocol information extraction tool. The three traces in the protocol information are (i) one or more protocol rules are used to extract packets from the signal level information as a first trace, (ii) transaction rules are applied on packets to extract transaction as a second trace, and (iii) software level rules including file read applied on transactions to extract the software level operations as a third trace. Based on output of the first trace, the packets are determined. The transaction is determined based on the packets and software operations are determined based on the transactions. In an embodiment, an error is detected by checking if one or more protocol rules are being violated.

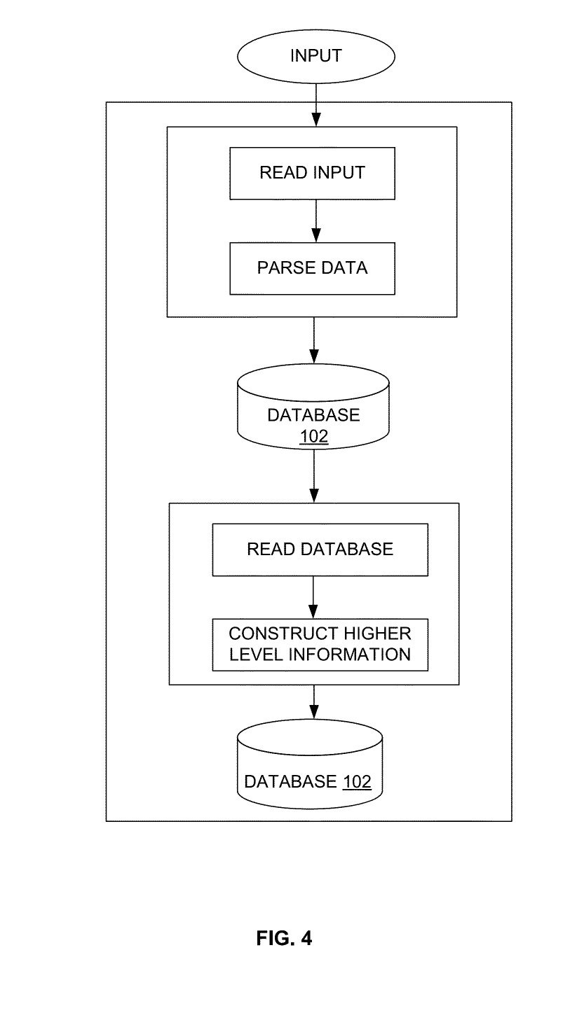

FIG. 4 illustrates a block diagram of a multi-level parsing operation, according to an embodiment. A signal level information obtained from a simulated and an emulated design is provided to the protocol information extraction tool 100. The protocol information extraction tool 100 reads the signal level information and a multilevel parsing process is performed to obtain multiple abstraction level views of the protocol information. In one embodiment, the lower level protocol information is represented by symbolic representations (e.g., Meta characters). In one embodiment, successive transactions, when represented by such “meta-characters” may form a “meta-string”. The “meta-string” may be parsed using a grammar that encodes how to construct the higher level protocol information from the lower level protocol information. In one embodiment, the higher level protocol information is recognized based on parsing operation. For example, USB2 Transactions consist of pre-defined sequences of USB2 Packets. By representing USB2 Packets using symbols (e.g., “meta characters”) as shortened representations of different USB2 Packet types, our parsing methodology may be used to construct USB2 Transactions from USB2 Packets. This methodology is generic and may be used for a broad range of protocols. If meta-characters for packets are defined as follows:

usb2_token_out_packet=“u2top”

usb2_data0_packet=“u2dp”

usb2_ack_handshake_packet=“u2 hp”

then, grammar rules for usb2 transactions may be written as follows:

usb2_transactions=usb2_token_packet usb2_data_packet usb2_handshake_packet.

In this case, instead of matching whole protocol stream (string of bits) one more time, just by matching the packet meta-characters, transactions may be constructed.

For example:

packet_stream=“u2topu2dpu2 hp”

Transaction after parsing “packet_stream” with the above grammar may appear as follows:

| TID | Type | Address | Endpoint |
|---|---|---|---|
| 1 | BULK_OUT | 0000001 | 0001 |

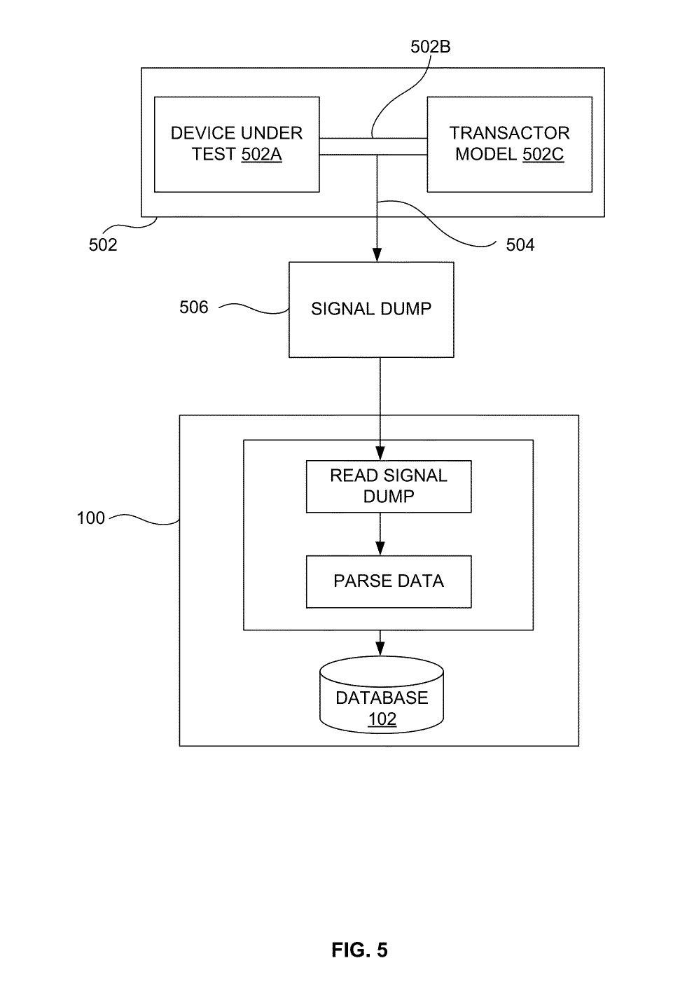

FIG. 5 is an exemplary view of a data extraction from a field-programmable gate array (FPGA)/Emulator, according to an embodiment. The view includes the simulated or the emulation design 502, a probe 504, a signal dump 506, and the protocol information extraction tool 100. The emulation design 100 further includes a device under test (DUT) 502A, an interface 502B, and a transactor model 502C. The device under test (DUT) 502A of the simulated design 502 interacts with the protocol information extraction tool 100 to analyze behavior and debugs one or more errors/issues. The protocol information extraction tool 100 obtains signal level information from the interface 502B of the simulated environment 502 (e.g., by plugging-in a monitor, or by reading signal level activity files or by electrically probing wire interfaces). The protocol information extraction tool then processes the information according to one or more protocol rules followed by the interface 502B. The processing of the raw information from the interface 502B is performed by parsing the raw information using a BNF grammar rules (e.g., a set of Backus Naur Form (BNF) grammar rules) to build higher level protocol information. The parsing operation delivers required higher level protocol information. The protocol information is made available to a user through graphical user interface (GUI) visualization that enables the user to debug protocol issues/error scenarios. The protocol information extraction tool 100 obtains the information associated with the interface 502B from FPGA/Emulator using the probes 504. In one embodiment, the signal level information associated with the interface 502B is read from the signal dump 508 and then the high level protocol information is constructed.

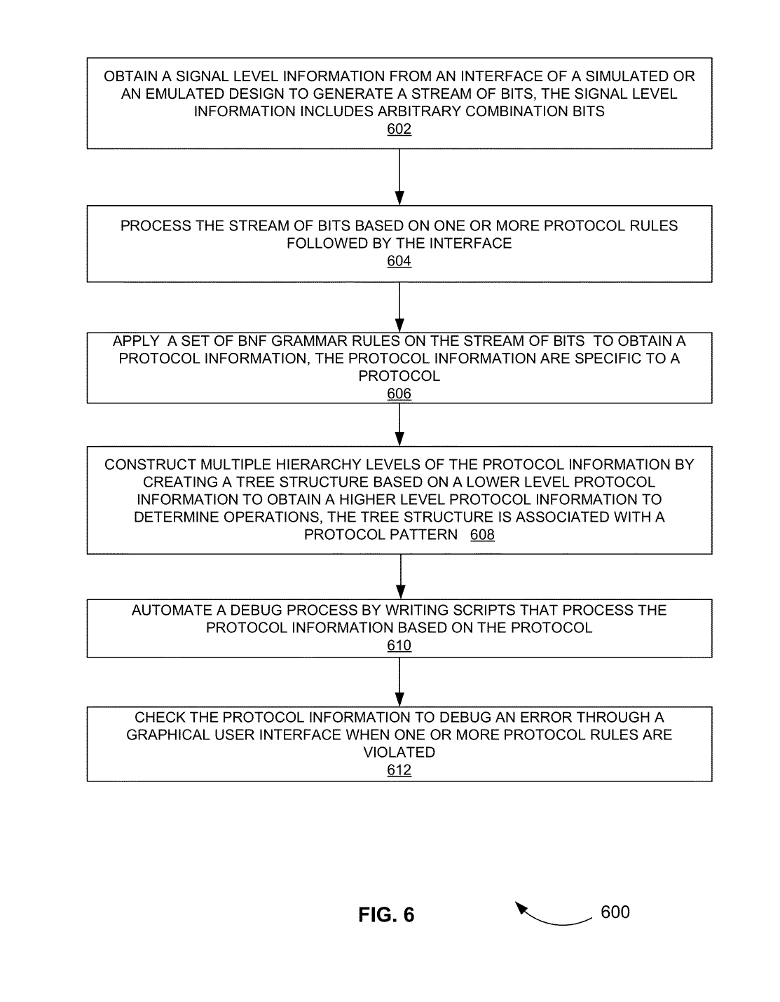

FIG. 6 is a flow diagram illustrating a process of extracting protocol information from a bus and/or interface to debug an error, according to an embodiment herein. At step, 602, a signal level information is obtained from the interface 502B of the simulated or emulated design 502 to generate a stream of bits. At step, 604, the stream of bits are processed based on one or more protocol rules followed by the interface 502B. At step, 606, BNF grammar rules are applied on the stream of bits to obtain a protocol information and the protocol information are specific to a protocol. At step, 608, multiple hierarchy levels of protocol information is constructed by creating a tree structure based on a lower level protocol information to obtain a higher level protocol information to determine operations and the tree structure includes branches and leaves specific to a protocol that is being parsed. At step, 610, a debug process is automated by writing scripts that process the protocol information based on the protocol to identify patterns in the protocol level packets and transactions that may indicate bugs. At step, 612, checking the protocol information to debug an error through a graphical user interface when one or more protocol rules are being violated.

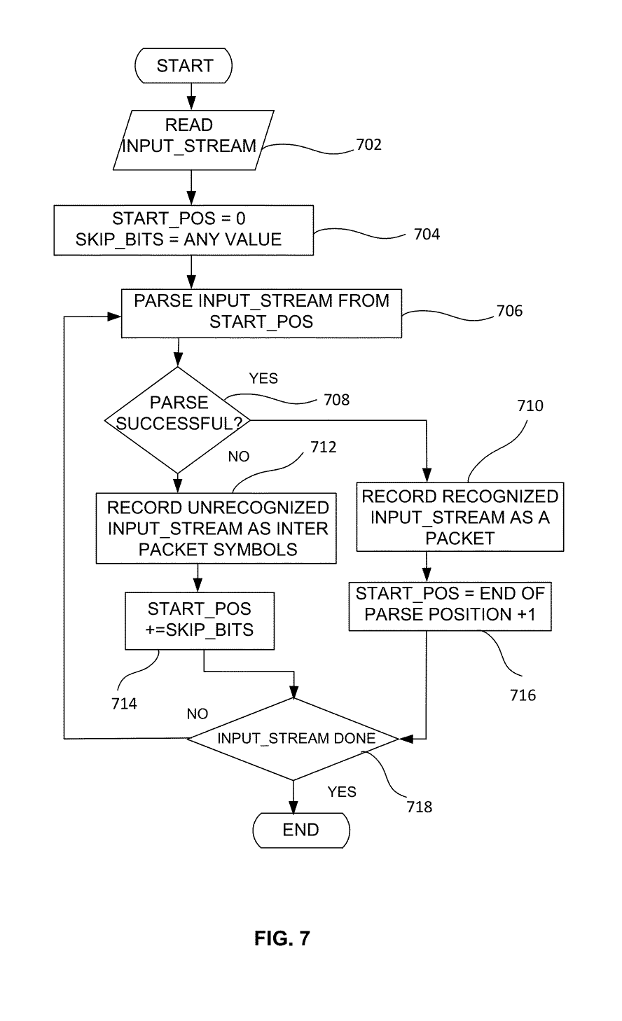

FIG. 7 is a flow diagram illustrating a method for eliminating an unrecognized stream of bits from being parsed by the protocol information extraction tool according to an embodiment. At step, 702, the protocol information extraction tool reads input_stream from a signal dump. The input_stream is a stream of bits. At step, 704, a start_pos is set to 0 to start the parsing of the input_stream and a skip_bits may be set to any value (depending upon the protocol which is being parsed). At step, 706, the input_stream is parsed starting from the start_pos. At step, 708, check if the input_stream is parsed, if yes store the recognized input_stream as a packet. (For example in the database 102) else store unrecognized input_stream as inter packet symbols. (for example in the database 102). At step, 714, the start_pos is updated to end of parse position+1 (end of parse position is an index until the input_stream is matched) if the input_stream is successfully parsed else the bits in the start of the input_stream is skipped by adding the skip_bits to the start_pos. At step, 718, checks if the input_stream is completely parsed to end the parsing else continue parsing until the input_stream is completely parsed.

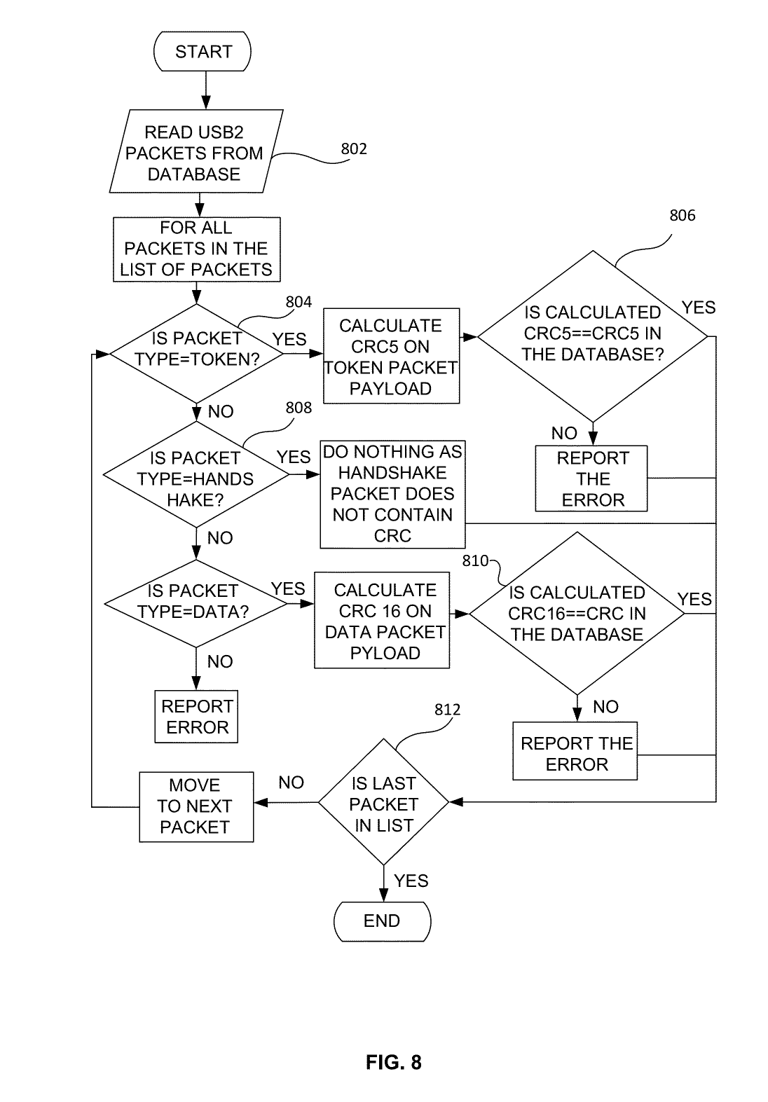

FIG. 8 is a flow diagram illustrating a method for automating a debug process by writing scripts on a protocol information according to an embodiment herein. At step, 802, all USB2 packets are read (For example from the database 102). At step, 804, check if PacketType equal to token packet, if yes calculate CRC5 on token packet payload and check if calculated CRC5 matches the CRC5 in the database 102 if yes then check if the token packet is a last token packet or not, if yes then end the debugging process else move to next token packet. At step, 806, if calculated CRC5 doesn't match the CRC5 in the database 102 then report an error. At step, 808, check if PacketType equal to handshake packet if no then check if PacketType is equal to Data Packet, if yes then calculate CRC16 on data packet payload and check if calculated CRC16 match the CRC5 in the database 102. At step 810, if calculated CRC16 doesn't match the CRC16 in the database 102 then report an error. At step 812, check if the calculated CRC5 or CRC16 is for last packet or not, if no then move to next packet else end.

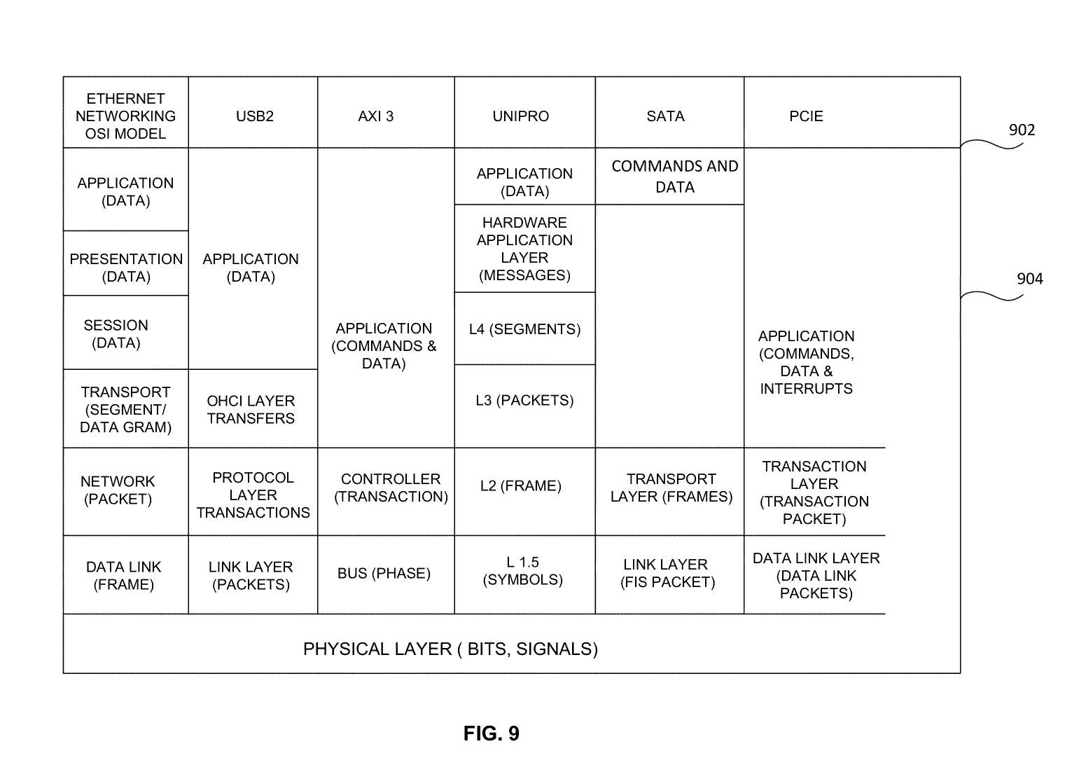

FIG. 9 illustrates a tabular view of different types of protocol 902 along with protocol information 904 according to an embodiment herein; The different types of protocol 902 are Ethernet networking OSI model, USB2, AXIS, Unipro, SATA, and PCIE. The Universal Serial Bus Version 2 (USB2) includes protocol information such as packets, transactions, transfers, The AXI includes protocol information such as phases and transactions, The Ethernet networking OSI model includes protocol information such as data, segments, datagram, packets and frames, The Unipro includes protocol information such as data, messages, segments, packets, frames, and symbols, The Serial AT Attachment (SATA) such as protocol information such as frames and FIS packets, The Peripheral Component Interconnect Express (PCIE) includes protocol information such as commands, data, interrupts, translation packet, and data link layer packets.

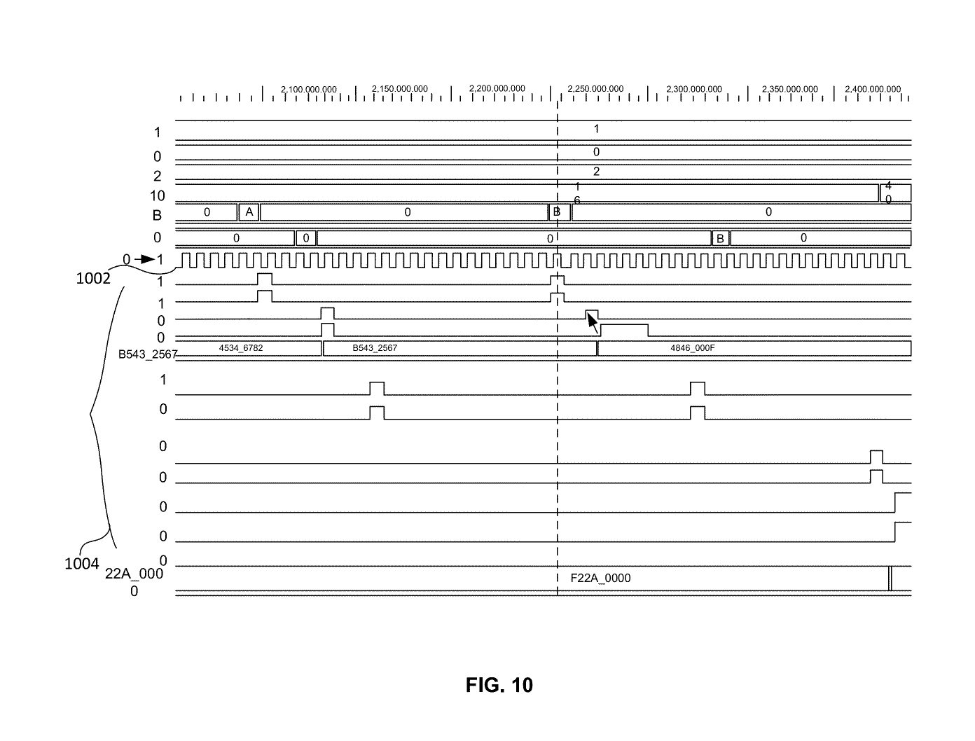

FIG. 10 is a user interface view illustrating a signal toggle for a USB2 protocol, according to an embodiment. The view includes a time signal 1002 and stream of bits 1004. The stream of bits 1004 includes information on signal toggles.

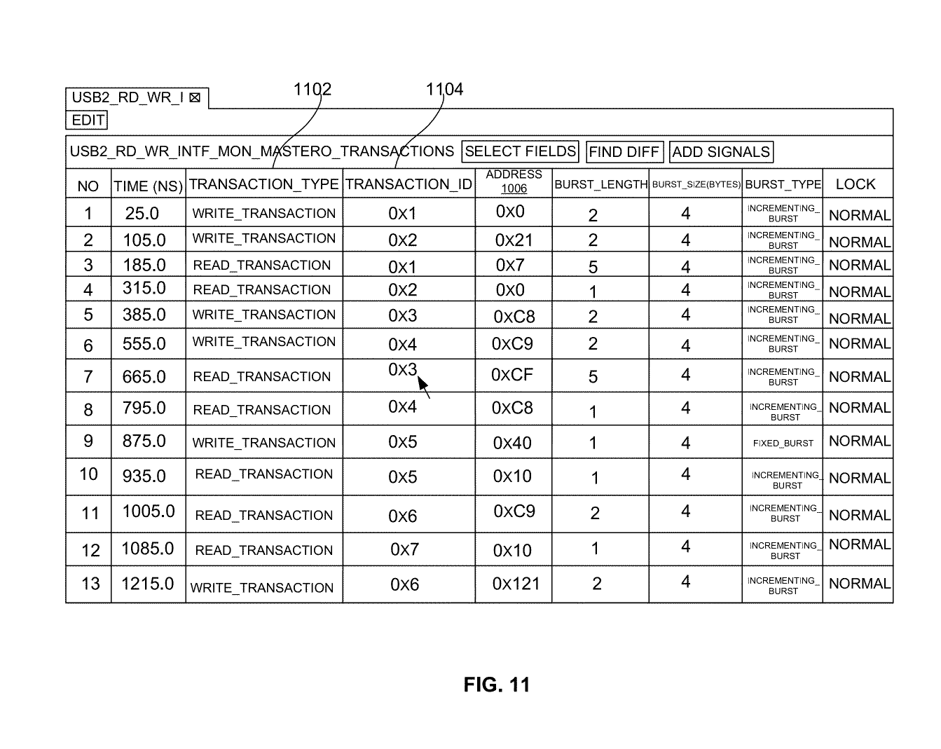

FIG. 11 illustrates a user interface view of protocol information including a transaction type, a transaction ID and an address, according to an embodiment. The view includes a protocol information, a transaction type 1102, a transaction ID 1104, and an address 1106. There are three transaction types 1102 and the three types 1102 are a write transaction, a read transaction and a protocol error. The transaction ID 1104 is a unique ID generated the protocol information. The address 1106 indicates a location where the protocol information is present in a memory.

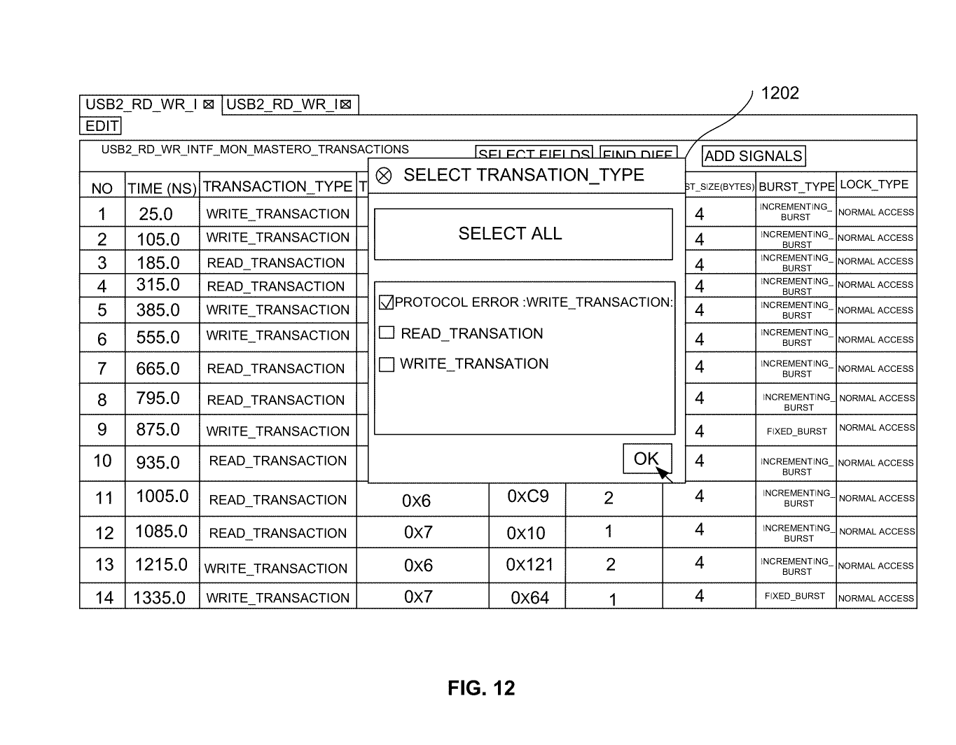

FIG. 12 illustrates a user interface view of selecting a protocol error, identified by the parsing module, from a transaction type, according to an embodiment. The view includes a selection window 1202 and the selection window includes a protocol error: write_transaction, a read_transaction and a write_transaction.

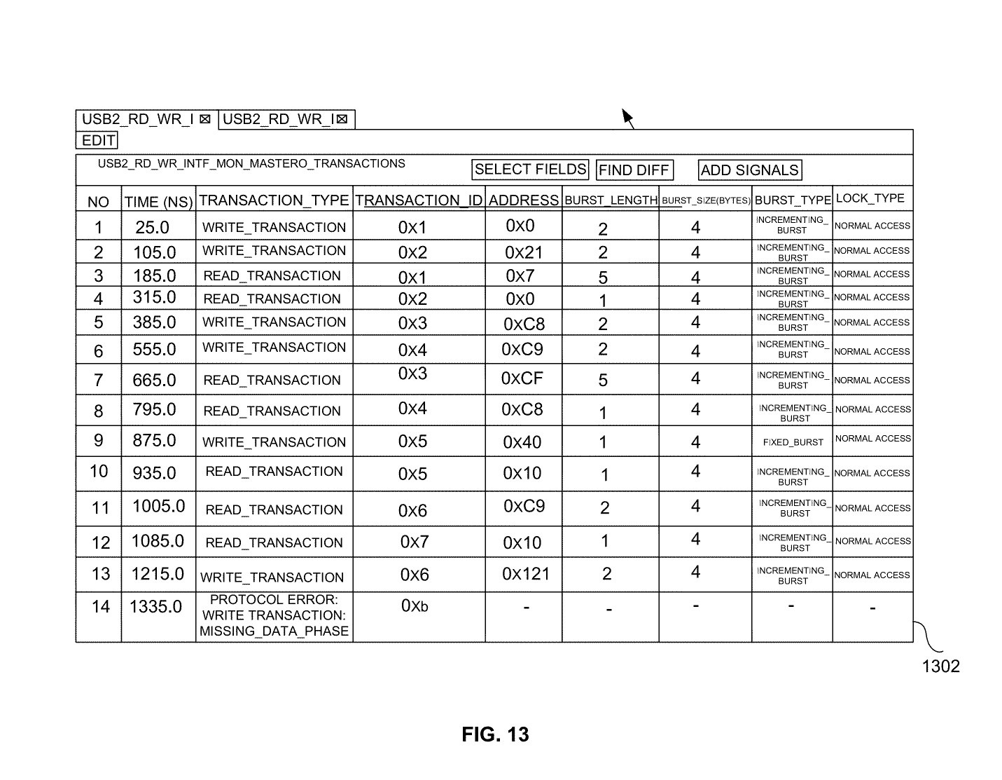

FIG. 13 illustrates a user interface view of a write transaction missing data phase, according to an embodiment. The view includes the protocol error of the write transaction missing data phase 1302. The data is steam of bits.

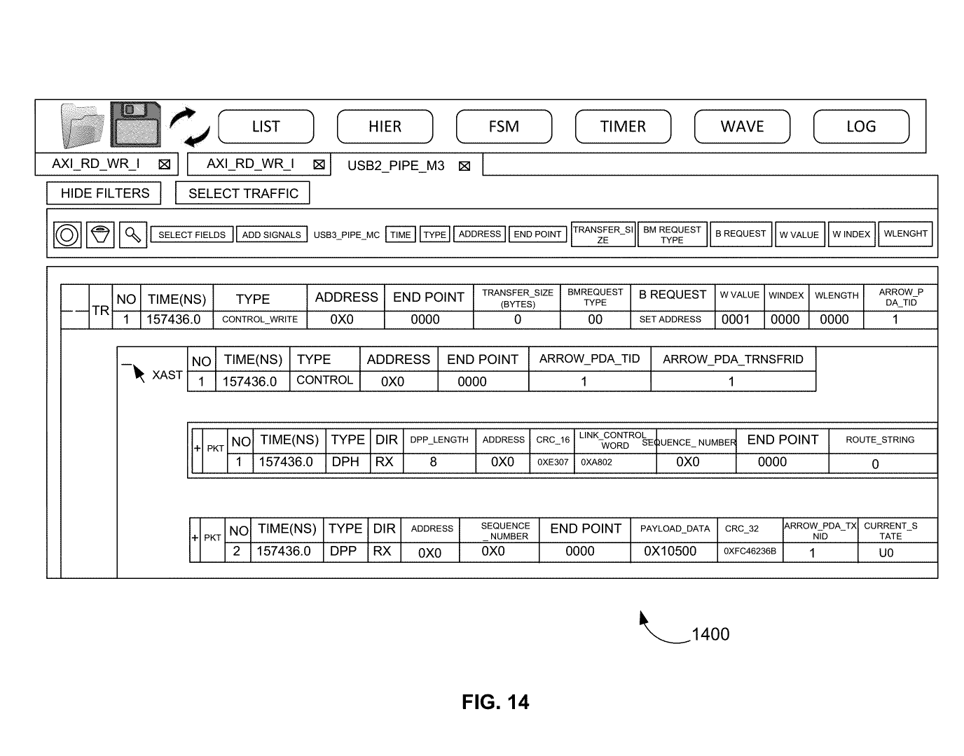

FIG. 14 illustrates a user interface view 1400 of a multiple hierarchy levels of a protocol information, according to an embodiment. The view includes a multiple hierarchy level of protocol information for the signal level information. In an embodiment, the signal level information may be specific to protocol such as USB2 and AXI2 protocol.

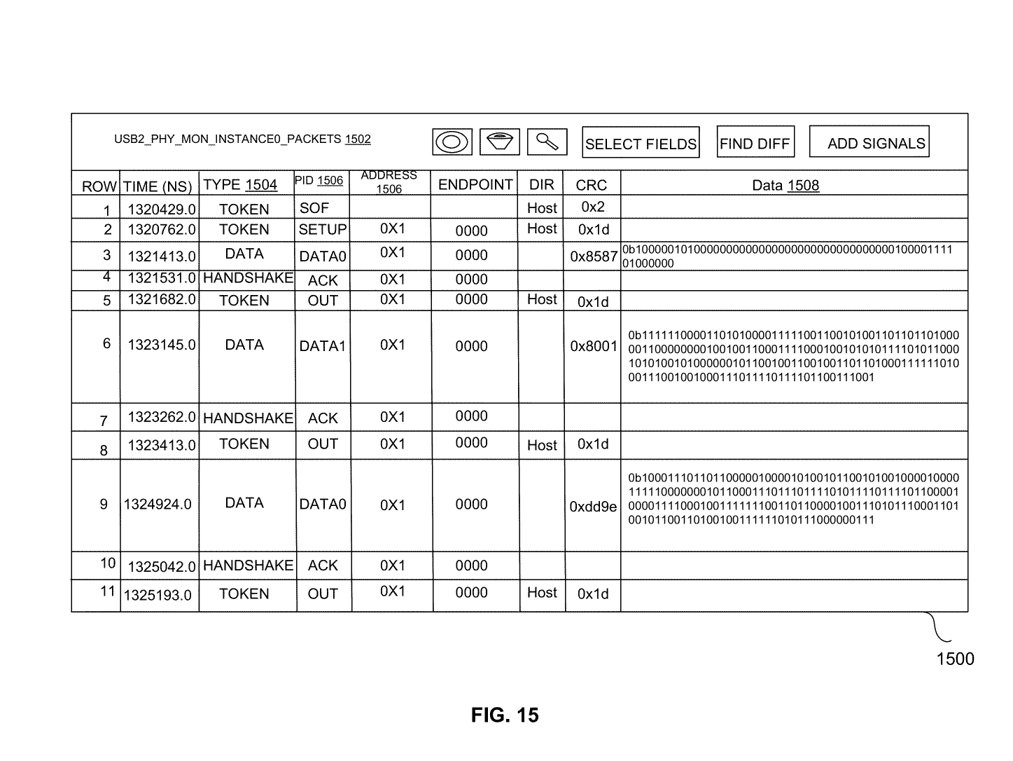

FIG. 15 illustrates a user interface view 1500 of a lower level protocol information of USB2 protocol according to an embodiment herein. The view includes type 1402, PID 1506, address 1506, and data 1508. The type 1502 denotes a USB2 packet type and the USB2 packet types are USB2_packet_handshake, USB2_packet_token, and USB2_packet_data. The PID 1506 is a packet ID. The address 1504 indicates a location where the protocol information is present in a memory. The data 1508 denotes stream of bits which is being parsed to obtain the lower level packet information of the USB2 protocol.

The embodiments herein may take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein may take the form of a computer program product accessible from a computer-usable or computer-readable medium providing program code for use by or in connection with a computer or any instruction execution system. For the purposes of this description, a computer-usable or computer readable medium may be any apparatus that can comprise, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) may be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet cards are just a few of the currently available types of network adapters.

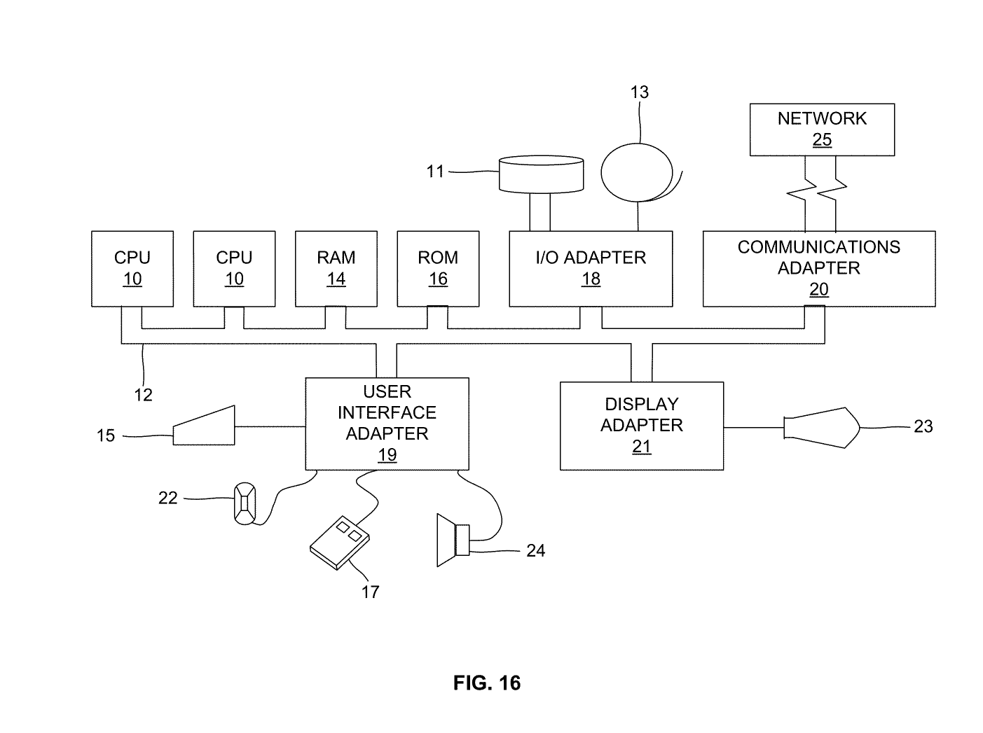

A representative hardware environment for practicing the embodiments herein is depicted in FIG. 16. This schematic drawing illustrates a hardware configuration of an information handling/computer system, in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 may connect to peripheral devices, such as disk units 11 and tape drives 13, or other program storage devices that are readable by the system. The system may read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The process of extracting data from the interface enables the user to obtain only the required protocol level information. The method of reading data from the interface and processing through a protocol parser removes the dependency on the Master/Slave model and also provides information at an abstraction that is useful to the engineer. This method may be used to construct higher level protocol information, so that analysis and/or debugging of the issue/error scenario become easier. Multiple hierarchy levels of information may be presented in a protocol. The usage of symbolic representations (e.g., Meta characters) to specify the data makes it easier to link the data between different levels. It also reduces the data that needs to be dealt with at higher levels.

This method may easily be adopted in existing verification environments, as it extracts data directly from the interfaces of the device under test (DUT). Further, this method may be used with software simulation as well as hardware emulation/prototype setups. The process of extracting trace from the interface makes easier to obtain required protocol level information thus eases the process of analysis. This method also points to the exact time along with the information of the protocol abstraction level in which the error has occurred.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A system for extracting protocol information from a simulated or an emulated design to analyze a system behavior, comprising:
a memory unit that stores a database, a set of modules, and instructions,
wherein said database comprises a protocol rule description table and an extracted protocol information table, wherein said protocol rule description table comprises one or more protocol rules to process a signal level information and said extracted protocol information table comprises data units associated with a second layer at a higher abstraction level than a first layer, wherein said second layer provides node to node data transfer, and wherein said data units are specific to a protocol;
a processor which when configured by said instructions executes said set of modules, wherein said set of modules comprises:
a signal extraction module, implemented by said processor, that extracts said signal level information from an interface of said simulated or said emulated design to generate a stream of bits, wherein said signal level information comprises an arbitrary combination of bits;
a signal processing module, implemented by said processor, that processes said stream of bits based on one or more protocol rules to obtain a protocol information that comprises a lower level protocol information and a higher level protocol information, wherein said one or more protocol rules comprise Backus Naur Form (BNF) grammar rules and said one or more protocol rules is specific to a protocol, wherein said signal processing module 106 comprises:
a protocol parsing module, implemented by said processor, that applies a said BNF grammar rules on said stream of bits to generate said lower level protocol information; and
a multi-level parsing module, implemented by said processor, configured to construct multiple hierarchy levels of said protocol information by creating a tree structure based on a lower level protocol information to obtain a higher level protocol information to determine operations, wherein said tree structure comprises branches and leaves based on said protocol which is being parsed.

2. The system of claim 1, wherein if said protocol is Universal Serial Bus (USB) then said extracted protocol information table comprises packets, transactions, transfers, wherein if said protocol is AXI then said extracted protocol information table comprises phases and transactions, wherein if said protocol is Ethernet networking OSI model then said extracted protocol information table comprises data, segments, datagram, packets and frames, wherein if said protocol is Unipro then said extracted protocol information table comprises data, messages, segments, packets, frames, and symbols, wherein if said protocol is Serial AT Attachment (SATA) then said extracted protocol information table comprises frames and FIS packets, wherein if said protocol is Peripheral Component Interconnect Express (PCIE) then said extracted protocol information table comprises commands, data, interrupts, translation packet, and data link layer packets.

3. The system of claim 1, wherein said signal processing module further eliminates an unrecognized stream of bits from being parsed.

4. The system of claim 1, further comprises a debug automation module, implemented by said processor, that automates a debug process by writing scripts that process said protocol information based on said protocol.

5. The system of claim 1, wherein said multi-level parsing module is obtained from plurality of protocol parsing module and said protocol parsing module is used to convert said signal level information into user readable language.

6. A processor implemented method for analyzing system behavior by parsing a stream of bits extracted from a simulated or an emulated design, said method comprising:
obtaining a signal level information from an interface of a simulated or an emulated design, wherein said signal level information consists of an arbitrary combination of bits;
generating a stream of bits based on said signal level information obtained from said interface of said simulated or said emulated design;
processing said stream of bits based on one or more protocol rules to generate a protocol information, wherein said one or more protocol rules comprise BNF grammar rules;
applying said BNF grammar rules on said stream of bits to generate a lower level protocol information, wherein said lower level protocol information is associated with said protocol information and said protocol information; and
eliminating an unrecognized stream of bits from being parsed.

7. A processor implemented method for analyzing system behavior of claim 6, wherein said method further comprising:
constructing multiple hierarchy levels of said lower level protocol information based on a multi-level parsing by creating a tree structure based on said lower level protocol information to obtain a higher level protocol information for determining operations, wherein said higher level protocol information, and said operations are specific to a protocol; and
automating a debug process by writing scripts that process said protocol information based on said protocol.

8. The processor implemented method of claim 7, wherein said method further comprises checking said protocol information to debug an error through a graphical user interface when said one or more protocol rules are being violated.

9. The processor implemented method of claim 6, wherein if said protocol is Universal Serial Bus (USB) then said protocol information comprises packets, transactions, transfers, wherein if said protocol is AXI then said protocol information comprises phases and transactions, wherein if said protocol is Ethernet networking OSI model then said protocol information comprises data, segments, datagram, packets and frames, wherein if said protocol is Unipro then said protocol information comprises data, messages, segments, packets, frames, and symbols, wherein if said protocol is Serial AT Attachment (SATA) then said protocol information comprises frames and FIS packets, wherein if said protocol is Peripheral Component Interconnect Express (PCIE) then said protocol information comprises commands, data, interrupts, translation packet, and data link layer packets.

10. A system that executes said method of claim 6.

11. One or more non-transitory computer readable storage mediums storing one or more sequences of instructions, which when executed by one or more processors, analyzes system behavior by parsing a stream of bits extracted from a simulated or an emulated design, said method comprising:
obtaining a signal level information from an interface of a simulated or an emulated process, wherein said signal level information consists of an arbitrary combination of bits;
generating a stream of bits based on said signal level information obtained from said interface of said simulated or said emulated design;
processing said stream of bits based on one or more protocol rules to generate a protocol information, wherein said one or more rules of said protocol comprise BNF grammar rules;
applying said BNF grammar rules on said stream of bits to generate a lower level protocol information, wherein said lower level protocol information is associated with a protocol information and said protocol information; and
eliminating an unrecognized stream of bits from being parsed.

12. The one or more non-transitory computer readable storage mediums storing one or more sequences of instructions of claim 11, further comprises:
constructing a multiple hierarchy levels of said lower level protocol information based on a multi-level parsing to obtain a higher level protocol information for determining operations, wherein said multi-level parsing is performed by creating a tree structure and said tree structure comprises branches and leaves.

13. The one or more non-transitory computer readable storage mediums storing one or more sequences of instructions of claim 12, said method further comprises checking said protocol information to debug an error through a graphical user interface when said one or more rules is being violate.

14. The one or more non-transitory computer readable storage mediums storing one or more sequences of instructions of claim 11, wherein if said protocol is Universal Serial Bus (USB) then said protocol information comprises packets, transactions, transfers, wherein if said protocol is AXI then said protocol information comprises phases and transactions, wherein if said protocol is Ethernet networking OSI model then said protocol information comprises data, segments, datagram, packets and frames, wherein if said protocol is Unipro then said protocol information comprises data, messages, segments, packets, frames, and symbols, wherein if said protocol is Serial AT Attachment (SATA) then said protocol information comprises frames and FIS packets, wherein if said protocol is Peripheral Component Interconnect Express (PCIE) then said protocol information comprises commands, data, interrupts, translation packet, and data link layer packets.

15. A system that executes said method of claim 11.
